(19) United States
(12) Patent Application Publication
(10) Pub. No.: US 2013/0228632 A1
(43) Pub. Date: Sep. 5, 2013

(54) CONTROLLING A COOLING SYSTEM FOR A COMPUTER SYSTEM

(71) Applicant: APPLE INC., Cupertino, CA (US)

(72) Inventors: Gaurav Kapoor, Santa Clara, CA (US); Keith Cox, Campbell, CA (US); Karen S. Eckert, San Jose, CA (US); Michael Bergh, Campbell, CA (US)

(73) Assignee: APPLE INC., Cupertino, CA (US)

(21) Appl. No.: 13/630,999

(22) Filed: Sep. 28, 2012

Related U.S. Application Data
(60) Provisional application No. 61/606,240, filed on Mar. 2, 2012.

(51) Int. Cl. G05D 23/19

(52) U.S. Cl. 236/94

(57) ABSTRACT

The disclosed embodiments provide an apparatus that controls a cooling system for a computer system. During operation, the apparatus monitors a temperature signal from the computer system to determine a trend for the temperature signal. Then, a filter parameter for a trend-based filter is selected based on the trend. Next, the temperature signal is filtered using the trend-based filter to generate a filtered temperature signal which is then passed through a controller to generate a control signal for the cooling system.

### RELATED APPLICATION

This application hereby claims priority under 35 U.S.C. §119 to U.S. Provisional Application No. 61/606,240, entitled “Controlling a Cooling System for a Computer System” by Gaurav Kapoor, Keith Cox, Karen S. Eckert and Michael R. Bergh, filed 2 Mar. 2012 (Atty. Docket No.: APL-P12671USP1).

### BACKGROUND

1. Field

The present embodiments relate to techniques for controlling a cooling system. More specifically, the present embodiments relate to techniques for controlling a cooling system for a computer system.

2. Related Art

As computer systems shrink in size and the power consumed by the chips in these systems increases, not only is more heat generated in these chips but the temperature of the chips can undergo larger and more rapid fluctuations. These temperature fluctuations can be due to a number of causes, including noise and the rate at which these high power chips can increase their power consumption (e.g., by entering a “turbo” mode) and, therefore, heat generation.

Many chips include thermal self-protection mechanisms that will throttle the performance of the chip based on built-in temperature sensors. However, these self-protection mechanisms typically result in a dramatic performance reduction in order to reduce the heat generated by the chip. This can significantly affect the performance of the computer system and result in a poor user experience.

Additionally, due to noise and other spikes in the temperature signal from the chip, a fan controller trying to control the temperature of the chip may cause the fan speed to fluctuate, leading to poor acoustics and an unpleasant user experience. If the temperature signal is low-pass filtered to remove the rapid fluctuations, then the transient response of the fan controller will be slowed and real spikes in the temperature of the chip may not be adequately addressed by the fan controller. Alternatively, if the low-pass filter is adjusted to let rapid temperature spikes through, then more noise will pass through which may result in poor acoustic performance.

Furthermore, typical low-pass filtering methods may converge to the mean of the temperature signal and not the peak envelope of the temperature spikes in the signal. In some computer systems, rapid temperature spikes above the mean filtered signal could cause the chip's self-protection mechanism to throttle performance of the chip, resulting in a poor user experience.

Lastly, more fine-tuned control of the heat generated and removed from a chip may result if the cooling system can control both the load sent a processor and the speed of the cooling fan to ensure that neither the acoustic performance of the fan nor the speed of the computer system results in an unpleasant user experience.

Hence, use of computer systems may be facilitated by improvements related to controlling a cooling system in a computer system.

### SUMMARY

The disclosed embodiments provide an apparatus that controls a cooling system for a computer system. During operation, the apparatus monitors a temperature signal from the computer system to determine a trend for the temperature signal. Next, a filter parameter for a trend-based filter is selected based on the trend. Then, the temperature signal is filtered using the trend-based filter to generate a filtered temperature signal which is then passed through a controller to generate a control signal for the cooling system.

In some embodiments, passing the filtered temperature signal through the controller involves preprocessing the filtered temperature signal to generate a peak envelope signal.

In some embodiments, determining the trend includes periodically determining the trend, and generating the peak envelope signal involves adding an adjusted error to the filtered temperature signal. Generating the adjusted error involves, each time the trend is below a predetermined threshold, generating an error value wherein the error value is a difference between the temperature signal and the filtered temperature signal. Next, a maximum error is determined during a previous predetermined time period based on one or more error values generated during the previous predetermined time period. Then, the maximum error is filtered to generate the adjusted error

In some embodiments, filtering the maximum error to generate the adjusted error involves using a first predetermined filter when the maximum error is positive and a second predetermined filter when the maximum error is negative.

In some embodiments, filtering the maximum error to generate the adjusted error involves using a first predetermined filter when the maximum error is increasing and a second predetermined filter when the maximum error is decreasing.

In some embodiments, determining the trend includes periodically determining the trend, and generating the peak envelope signal involves adding an adjusted error to the filtered temperature signal. Generating the adjusted error involves, each time the trend is below a predetermined trend threshold, generating an error value wherein the error value is a difference between the temperature signal and the filtered temperature signal. Next, a maximum error is determined and a counter is increased by a first predetermined amount. Then, when the counter is greater than or equal to a first predetermined count threshold, the maximum error is filtered to generate the adjusted error. Furthermore, each time the trend is above the predetermined trend threshold, the counter is decreased by a second predetermined amount, and when the counter is less than or equal to a second predetermined count threshold, the maximum error is set equal to zero.

In some embodiments, filtering the temperature signal using the trend-based filter involves filtering the temperature signal using a low-pass filter wherein the low-pass filter uses a trend-based filter parameter.

In some embodiments, the trend-based filter parameter is a predetermined high value when the trend is below a predetermined low threshold and a predetermined low value when the trend is above a predetermined high threshold.

In some embodiments, generating the control signal includes generating a cooling fan control signal and a throttling control signal.

In some embodiments, generating the throttling control signal involves generating a throttling control signal for an operating system of the computer system.

In some embodiments, the temperature signal involves a temperature signal of a die in the computer system.

In some embodiments, the die includes one of: a processor die, a graphics processing unit (GPU) die, and a die that includes a radio frequency (RF) power amplifier.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a computer system in accordance with an embodiment.

FIG. 2 depicts an exemplary graph showing a temperature signal and trend in accordance with an embodiment.

FIGS. 3A and 3B show exemplary graphs of the trend-based filter parameter vs. trend in accordance with embodiments.

FIG. 4 depicts an exemplary graph showing a temperature signal and a trend-based filtered signal in accordance with an embodiment.

FIG. 5 depicts an exemplary graph showing a temperature signal, a trend-based filtered signal and a peak envelope signal in accordance with an embodiment.

FIG. 6 shows a flowchart illustrating a process that generates a control signal in accordance with an embodiment.

FIG. 7 shows a flowchart illustrating a process that generates a peak envelope signal in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

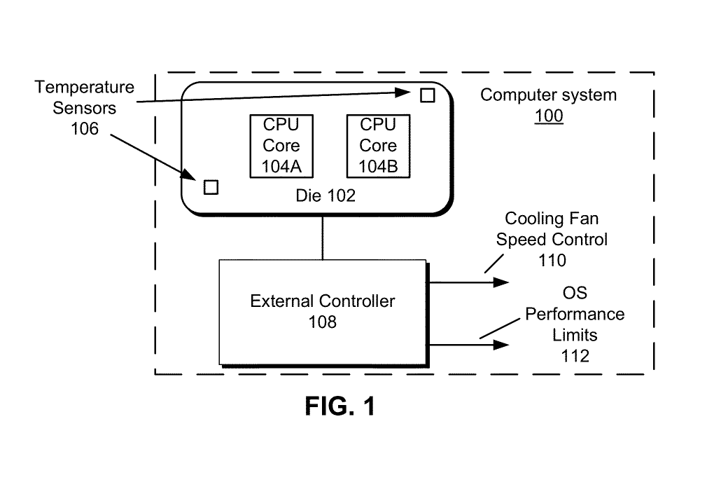

FIG. 1 shows a computer system in accordance with an embodiment. Computer system 100 includes die 102 with central processing unit (CPU) cores 104A and 104B and temperature sensors 106. External controller 108 is coupled to die 102 and generates outputs: cooling fan speed control 110, and operating system (OS) performance limits 112.

Computer system 100 can be any computer system that includes one or more components that generate heat and whose temperature needs to be actively maintained within operating limits. Computer system 100 may include but is not limited to a desktop computer, a laptop computer, a tablet computer, or a smartphone.

Die 102 can be any die that contains one or more CPU cores. Note that die 102 is depicted with two CPU cores, 104A and 104B, but die 102 may have any number of CPU cores without departing from the invention. In some embodiments, die 102, and CPU cores 104A and 104B may be replaced by a die containing any circuitry that generates heat. For example, in some embodiments, die 102 and CPU cores 104A and 104B may be replaced by a die that includes a graphics processing unit (GPU) or a radio frequency (RF) power amplifier.

Temperature sensors 106 can be temperature sensors of any type and number, and can be placed in any one or more locations on die 102 and/or in any CPU cores or other circuitry on die 102. Temperature sensors 106 communicate the sensed temperature to external controller 108 using any suitable digital or analog signal transmission method. In some embodiments, temperature sensors 106 may report the temperature as a continuous signal, while in other embodiments the temperature is reported at regular intervals such as once per second. Note that any reporting interval can be used without departing from the invention.

External controller 108 is any module or apparatus that can receive the temperature signal from temperature sensors 106 and output cooling fan speed control 110 and OS performance limits 112 in accordance with the invention. External controller 108 can be implemented in any technology and in some embodiments external controller 108 is implemented using one or more resources of CPU cores 104A or 104B, or other resources of computer system 100 that are not depicted in FIG. 1. Additionally, in some embodiments, die 102 is a system on a chip (SoC) that may include one or more CPUs and/or other components, and external controller 108 may be implemented in hardware and/or software that runs partially or entirely on the SoC.

Note that in the discussion below, while we describe the process steps for one temperature signal, the same steps could be applied independently to each temperature signal from temperature sensors 106 without loss of generality. In some embodiments, a temperature signal from each of temperature sensors 106 is processed as described below, while in other embodiments temperature signals from temperature sensors 106 are combined (e.g., averaged) into one temperature signal for processing. In still other embodiments, when more than one temperature sensor is present on die 102, the temperature signals may be combined and analyzed in separate groups.

During operation of computer system 100, temperature sensors 106 measure the temperature of die 102. A temperature signal generated by temperature sensors 106 is transmitted to external controller 108. External controller 108 then determines the trend of the temperature signal. The trend of the temperature signal may be determined using any suitable technique. In one embodiment, the trend is determined as follows. The temperature signal is filtered one time using an infinite-impulse-response single-pole low-pass filter generating a signal f1. Signal f1 is then filtered a second time using the same filter to generate a signal f2. The trend is then determined by subtracting f2 from f1. In some embodiments, the filter may be realized using a discrete-time implementation, while in other embodiments the temperature signal is transformed to the frequency domain and filtered. Note that in some embodiments some or all of the signals may be represented as discrete time samples.

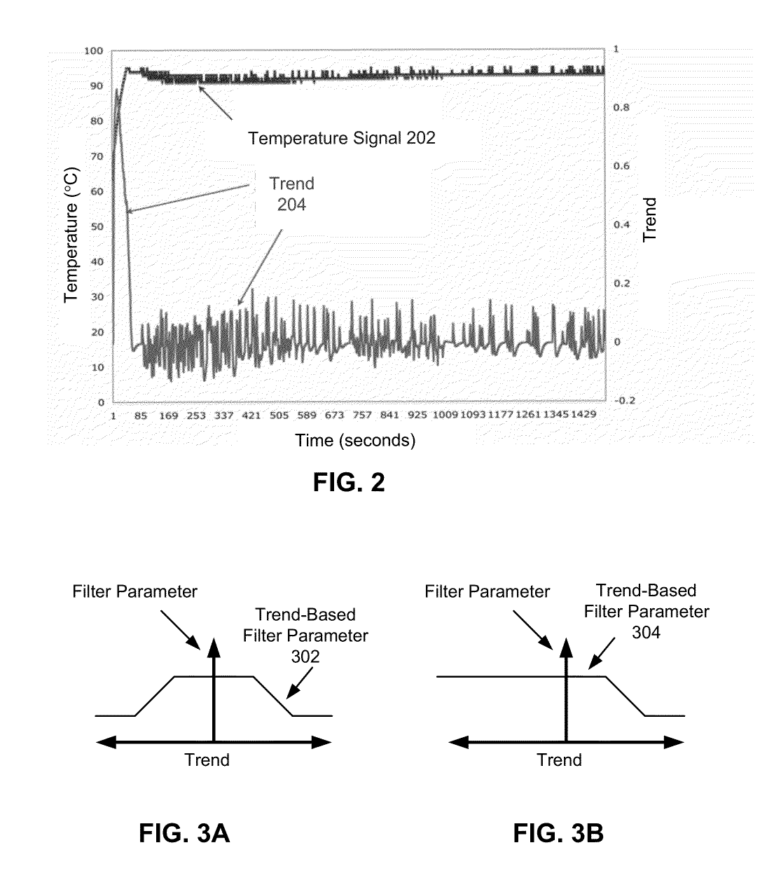

FIG. 2 depicts an exemplary graph of temperature signal 202 and trend 204 of computer system 100. Temperature signal 202 is a sample plot of a temperature signal measured by one of temperature sensors 106 with temperature in degrees Celsius on the vertical axis and time in seconds on the horizontal axis. For the plot of trend 204, the vertical axis is in relative units, and the horizontal axis is time in seconds. Note from FIG. 2 that trend 204 is larger during the transient rising portion of temperature signal 202 and smaller during the relatively steady-state portion of temperature signal 202.

Referring back to FIG. 1, after external controller 108 has determined the trend of the temperature signal, external controller 108 then selects a trend-based filter parameter based on the trend. FIGS. 3A and 3B depict exemplary graphs of trend-based filter parameters for use with embodiments. In these graphs the vertical axis is the filter parameter, and the horizontal axis is the trend. In FIG. 3A, trend-based filter parameter 302 is high when the absolute value of the trend is low, and low when the absolute value of the trend is high. In FIG. 3B, trend-based filter parameter 304 is high when the trend is low (including negative trend values) and low when the trend is high. Note that in some embodiments trend-based filter parameter 302 may be used, while in other embodiments trend-based filter parameter 304 may be used. Additionally, note that other functional relationships between trend and filter parameter can be used to determine the trend-based filter parameter without departing from the present invention. The determination of which trend-based filter parameter to use will be discussed below.

Returning to the operation of external controller 108, when external controller 108 has selected a filter parameter based on the trend determined from the temperature signal, external controller 108 then filters the temperature signal using a filter based on the selected trend-based filter parameter. In some embodiments, the temperature signal is filtered using a low-pass filter with a time constant based on the selected trend-based filter parameter.

In these embodiments, if trend-based filter parameter 302 is used, then when the absolute value of the trend is high, the time constant of the low-pass filter is low. This broadens the pass-band of the low-pass filter, allowing higher frequency components of the temperature signal to pass through the filter so that the filtered signal can more closely follow the high magnitude trend present in the temperature signal. When the absolute value of the trend is low, the time constant is high, narrowing the pass-band of the filter and attenuating the high frequency components in the temperature signal (e.g., noise) while allowing the low frequency portion of the temperature signal to pass through.

Note that, when trend-based filter parameter 302 is used, highly negative trends are filtered with a low time-constant low-pass filter. This allows more high frequency components through the filter so that the large magnitude negative trend can be tracked as the temperature signal goes down in value (i.e., negative trend). Alternatively, when trend-based filter parameter 304 is used, then highly negative trends are filtered with a larger time constant. This allows fewer high frequency components through the filter, so that large magnitude negative trends are not fully tracked and the filtered temperature signal, therefore, does not go down (i.e., follow the negative trend) as quickly as the temperature signal.

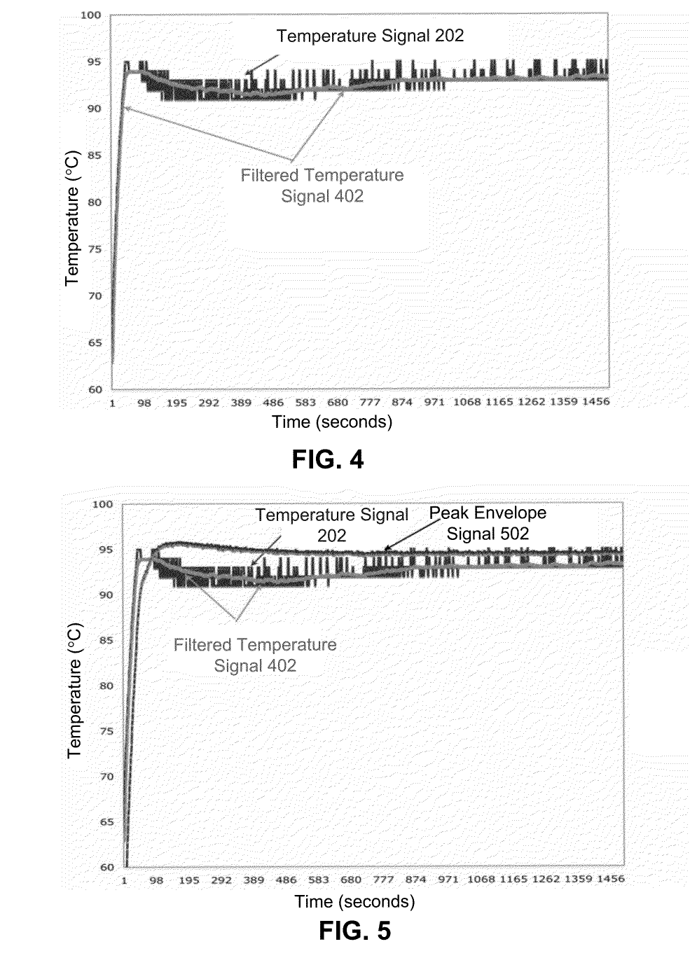

FIG. 4 depicts an exemplary graph showing the temperature signal 202, and a filtered temperature signal 402 with temperature in degrees Celsius on the vertical axis and time in seconds on the horizontal axis. Note that filtered temperature signal 402 converges to the mean temperature signal 202.

Note that generally the shape and/or values of the filter parameter vs. trend for the trend-based filter parameter can be determined based on information, including but not limited to the output of the trend-based filter compared to the temperature signal (i.e., the input) for a variety of operation modes of computer system 100. Additionally, in some embodiments, the shape and values of the filter parameter vs. trend graph for a trend-based filter parameter may be selected based on performance characteristics of computer system 100, or any subsystem within computer system 100, such as the acoustics of a cooling fan, the throttling of processor speed, or other user experience related performance criteria.

In some embodiments, the filtered temperature signal is further processed to generate a peak envelope signal that converges to near or at the peak of the temperature signal. In one embodiment, external controller 108 generates the peak envelope signal as follows. In the case when the trend is below a predetermined value, external controller 108 generates an error value by subtracting the filtered temperature signal from the temperature signal. The external controller then determines the maximum error over a predetermined previous time period (e.g., 10 seconds). The maximum error values are then low-pass filtered, and this filtered maximum error is added to the trend-based filtered signal to generate the peak envelope signal. In some embodiments, a maximum error is determined for each previous predetermined time period, and this set of maximum error values is low-pass filtered using a discrete-time implementation of a low-pass filter.

Note that in some embodiments, the filter (e.g., type of filter and/or filter parameters) used to filter the maximum error values may be determined based on one or more characteristics of the set of maximum error values and/or the filtered maximum error, including but not limited to whether the current value of the maximum error is positive or negative, or if the current trend of the maximum error is increasing or decreasing. For example, the set of maximum error values may be filtered using first type of filter when the current maximum error is greater than the current filtered maximum error and a second type of filter when the current maximum error is less than the current filtered maximum error.

In the case when the trend is above the predetermined value, the previous filtered maximum error is added to the trend-based filtered signal to generate the peak envelope signal. In some embodiments, when the trend is above the predetermined value, the trend-based filtered signal is used as the maximum envelope signal. Note that in some embodiments the filter parameter, and type of filter used to filter the maximum error, and the predetermined previous time period over which each maximum error value is determined are selected based on the relationship between the maximum envelope signal and the temperature signal, and performance characteristics of computer system 100, or any subsystem within computer system 100, such as the acoustics of a cooling fan, the throttling of processing speed, or other user experience related performance criteria.

FIG. 5 depicts an exemplary graph showing the temperature signal 202, filtered temperature signal 402, and peak envelope signal 502 with temperature on the vertical axis and time on the horizontal axis. Note that peak envelope signal 502 converges to near the peak of temperature signal 202.

Referring back to FIG. 1, external controller 108 then uses peak envelope signal 502 to generate cooling system control signals, such as cooling fan speed control 110 and OS performance limits 112. In some embodiments, cooling fan speed control 110 and OS performance limits 112 are generated by external controller 108 using one or more proportional-integral-derivative (PID) controllers (not shown) operating within or outside of external controller 108. In the embodiment of FIG. 1, cooling fan speed control 110 is used to control the speed of one or more cooling fans (not shown) positioned to cool die 102, and OS performance limits 112 are used by an operating system (not shown) of computer system 100 to set performance limits for one or more of CPU cores 104A and 104B to control the heat generated in the CPU cores. The performance limits may be imposed by the OS using any available mechanism under the control of the OS, including but not limited to one or more of reducing the clock speed; and controlling the timing and/or type of work in an input queue, including transferring work to the queue of another processor, or any other mechanism that can reduce or otherwise control the heat generated by a CPU.

Note that, in embodiments with multiple temperature sensors, external controller 108 can generate a filtered temperature signal and/or a peak envelope signal for the temperature signal from each temperature sensor. External controller 108 can then generate cooling system control signals, such as cooling fan speed control 110 and OS performance limits 112, based on the largest of the filtered temperature signals or peak envelope signals generated from the multiple temperature signals. In some embodiments, external controller 108 can generate independent cooling system control signals for multiple fans and/or OS performance limits for multiple CPU cores based on temperature signals from multiple temperature sensors on a die. For example, in some embodiments, each CPU core of a die has an associated temperature sensor that generates a separate temperature signal that is communicated to the external controller. The external controller generates peak envelope signals based on each temperature signal using the process described herein. The external controller then generates a control signal to control the cooling fan speed based on the highest peak envelope signal, while the OS performance limits for each CPU core are determined based on the peak envelope signal for the temperature signal from the temperature sensor associated with each CPU core.

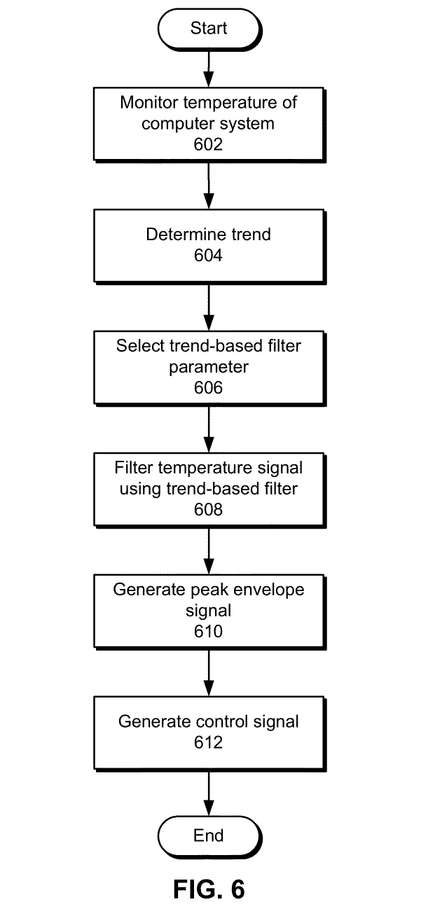

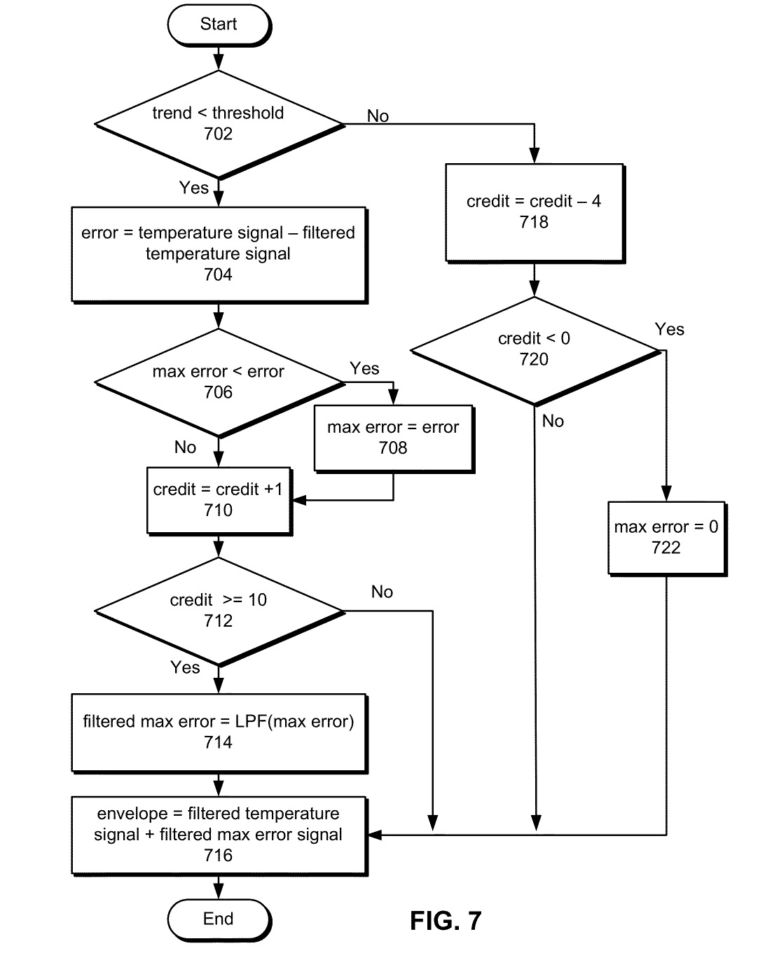

FIG. 6 shows a flowchart illustrating a process that generates a cooling system control signal in accordance with an embodiment. First, the temperature of a computer system is monitored (step 602). Then, the trend of the monitored temperature signal is determined (step 604), and a trend-based filter parameter is selected based on the trend (step 606). Next, the temperature signal is filtered using the trend-based filter parameter in a trend-based filter (step 608). A peak envelope signal is generated based on the temperature signal, the trend, and the filtered temperature signal (step 610). Note that step 610 will be discussed in more detail below with reference to FIG. 7. Then, a cooling system control signal is generated based on the peak envelope signal (step 612).

FIG. 7 shows a flowchart illustrating the process of generating a peak envelope signal from the temperature signal, the trend, and the filtered temperature signal in accordance with an embodiment. First, if the trend is less than a predetermined trend threshold (step 702), then an error value is generated by subtracting the filtered temperature signal from the temperature signal (step 704). Then, if the maximum error is less than the error value (step 706), the maximum error is set equal to the error value (step 708) and the process continues at step 710. If the maximum error is not less than the error values (step 706), then the process also continues to step 710. At step 710, a credit counter is increased by one.

Then, if the credit counter is greater than or equal to a predetermined count threshold (shown as 10) (step 712), a filtered maximum error is generated by low-pass filtering the maximum error values generated during each of one or more previous predetermined time periods (step 714). In some embodiments, all of the previously generated maximum error values are low-pass filtered at this step. Note that as discussed above, the filter parameter for the low-pass filter at this step may be selected based on characteristics of the maximum error values and/or the filtered maximum error such as if the current maximum error value is positive or negative, or if the current maximum error value is greater than or less than the current filtered maximum error. Additionally, in some embodiments, the credit counter is reset and the maximum error value is stored in a set of time-ordered maximum error values. Then, a new maximum error value is determined (i.e., at step 708) until the credit counter again reaches the predetermined count threshold.

The process then continues on to step 716. At step 712 if the credit counter is not greater than or equal to 10, then the process also continues to step 716. At step 716, the peak envelope signal is generated by adding the filtered temperature signal to the filtered maximum error signal.

Referring back to step 702, if the trend is not less than the predetermined trend threshold (step 702) then the credit counter is decreased by a predetermined amount (shown as 4) (step 718). Then, if the credit counter is not less than 0 (step 720), the process continues to step 716. If the credit counter is less than 0 (step 720), then the maximum error is set to 0 (step 722) and the process continues to step 716.

Note that in some embodiments the predetermined count threshold in step 712 and the predetermined amount (shown as 4) in step 718 can be determined based on performance characteristics of the computer system, or any subsystem within computer system, such as the acoustics of a cooling fan, the throttling of processing speed, or other user experience related performance criteria.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for controlling a cooling system for a computer system, comprising:
monitoring a temperature signal from the computer system to determine a trend for the temperature signal;
selecting a filter parameter for a trend-based filter based on the determined trend;
filtering the temperature signal using the trend-based filter to generate a filtered temperature signal; and
passing the filtered temperature signal through a controller to generate a control signal to control the cooling system.

2. The method of claim 1, wherein passing the filtered temperature signal through the controller involves preprocessing the filtered temperature signal to generate a peak envelope signal.

3. The method of claim 2, wherein determining the trend includes periodically determining the trend, and generating the peak envelope signal involves adding an adjusted error to the filtered temperature signal, and generating the adjusted error involves:
each time the trend is below a predetermined threshold,
generating an error value wherein the error value is a difference between the temperature signal and the filtered temperature signal;
determining a maximum error during a previous predetermined time period based on one or more error values generated during the previous predetermined time period; and
filtering the maximum error to generate the adjusted error.

4. The method of claim 3, wherein filtering the maximum error to generate the adjusted error involves using a first predetermined filter when the maximum error is positive, and a second predetermined filter when the maximum error is negative.

5. The method of claim 3, wherein filtering the maximum error to generate the adjusted error involves using a first predetermined filter when the maximum error is increasing, and a second predetermined filter when the maximum error is decreasing.

6. The method of claim 2, wherein determining the trend includes periodically determining the trend, and generating the peak envelope signal involves adding an adjusted error to the filtered temperature signal, and generating the adjusted error involves:
each time the trend is below a predetermined trend threshold,
generating an error value;
determining a maximum error;
increasing a counter by a first predetermined amount;
when the counter is greater than or equal to a first predetermined count threshold, filtering the maximum error to generate the adjusted error;
each time the trend is above the predetermined trend threshold,
decreasing the counter by a second predetermined amount; and
when the counter is less than or equal to a second predetermined count threshold, setting the maximum error equal to zero.

7. The method of claim 1, wherein filtering the temperature signal using the trend-based filter involves filtering the temperature signal using a low-pass filter wherein the low-pass filter uses a trend-based filter parameter.

8. The method of claim 7, wherein the trend-based filter parameter is:
a predetermined high value when the trend is below a predetermined low threshold; and
a predetermined low value when the trend is above a predetermined high threshold.

9. The method of claim 1, wherein generating the control signal includes generating a cooling fan control signal and a throttling control signal.

10. The method of claim 9, wherein generating the throttling control signal involves generating a throttling control signal for an operating system of the computer system.

11. The method of claim 1, wherein the temperature signal involves a temperature signal of a die in the computer system.

12. The method of claim 11, wherein the die includes one of: a processor die, a graphics processing unit (GPU) die, and a die that includes a radio frequency (RF) power amplifier.

13. A computer-readable storage medium storing instructions that when executed by a computer cause the computer to perform a method for controlling a cooling system for a computer system, comprising:
monitoring a temperature signal from the computer system to determine a trend for the temperature signal;
selecting a filter parameter for a trend-based filter based on the determined trend;
filtering the temperature signal using the trend-based filter to generate a filtered temperature signal; and
passing the filtered temperature signal through a controller to generate a control signal to control the cooling system.

14. The computer-readable storage medium of claim 13, wherein passing the filtered temperature signal through the controller involves preprocessing the filtered temperature signal to generate a peak envelope signal.

15. The computer-readable storage medium of claim 13, wherein determining the trend includes periodically determining the trend, and generating the peak envelope signal involves adding an adjusted error to the filtered temperature signal, and generating the adjusted error involves:
each time the trend is below a predetermined threshold,
generating an error value;
determining a maximum error during a previous predetermined time period based on one or more error values generated during the previous predetermined time period; and
filtering the maximum error to generate an adjusted error.

16. The computer-readable storage medium of claim 13, wherein filtering the temperature signal using the trend-based filter involves filtering the temperature signal using a low-pass filter, wherein the low-pass filter uses a trend-based filter parameter, and wherein the trend-based filter parameter is:
a predetermined high value when the trend is below a predetermined low threshold; and
a predetermined low value when the trend is above a predetermined high threshold.

17. The computer-readable storage medium of claim 13, wherein generating the control signal includes generating a cooling fan control signal and a throttling control signal.

18. The computer-readable storage medium of claim 17, wherein generating the throttling control signal involves generating a throttling control signal for an operating system of the computer system.

19. An apparatus for controlling a cooling system for a computer system, comprising:
a trend determining apparatus configured to determine a trend for a temperature signal for the computer system;
a filter parameter selecting module coupled to the trend determining module and configured to select a filter parameter for a trend-based filter based on the determined trend;
a trend-based filtering module coupled to the filter parameter selecting module and configured to filter the temperature signal using the trend-based filter; and
a controller coupled to the trend-based filtering module and configured to generate a control signal to control the cooling system based on a peak envelope signal generated using the filtered temperature signal.

20. The apparatus of claim 19, wherein the trend determining module, the filter parameter selecting module, the trend-based filtering module, and the controller are all implemented in a system-on-a-chip (SoC), and the temperature signal includes a temperature signal of the SoC.

21. The apparatus of claim 19, wherein the trend determining module, the filter parameter selecting module, the trend-based filtering module, and the controller are all implemented on an external controller on one or more controller dies, and the temperature signal includes a temperature signal of a processor die.

22. The apparatus of claim 19, wherein the control signal includes a cooling fan control signal and a throttling control signal, wherein the throttling control signal involves a throttling control signal for an operating system of the computer system.
